(19) United States
(12) Patent Application Publication
(10) Pub. No.: US 2009/0082500 A1
(43) Pub. Date: Mar. 26, 2009

(54) MODIFIED THERMALLY EXPANDABLE GRAPHITE AND MATERIAL CONTAINING THE SAME

(76) Inventors: Chin-Lung CHIANG, Changhua County (TW); Hui-Chung WANG, Taoyuan County (TW); Chia-Hsun CHEN, Taichung City (TW); Chen-Feng KUAN, Taichung County (TW); Hsu-Chiung KUAN, Kaohsiung City (TW); Wei-Hsin YEN, Tainan City (TW); Kun-Chang LIN, Tainan City (TW)

Correspondence Address: CHOATE, HALL & STEWART LLP, TWO INTERNATIONAL PLACE, BOSTON, MA, 02110, US

(21) Appl. No.: 12/145,315

(22) Filed: Jun. 24, 2008

(30) Foreign Application Priority Data
Jul. 17, 2007 (TW) 096126008

(51) Int. Cl. C08K 3/22; C08L 83/06; C08K 3/26; C08K 5/5415; C08K 5/18

(52) U.S. Cl. 524/255; 524/588; 524/437; 524/436; 524/425; 524/261

(57) ABSTRACT

A modified thermally expandable graphite includes a reaction product of an expandable graphite that contains an intercalation compound intercalated among lattice layers of the expandable graphite, and a silicon-containing organic compound that has at least one alkoxyl group and a reactive group subjected to reaction with the intercalation compound. A sol-gel reaction product of the modified thermally expandable graphite and a modified thermosetting polymeric precursor is also disclosed.

### BACKGROUND OF THE INVENTION

1. Field of the Invention

The invention relates to a modified thermally expandable graphite and a material containing the same, more particularly to a halogen-free and flame retardant modified thermally expandable graphite containing a reaction product of an expandable graphite and a silicon-containing organic compound having at least one alkoxyl group.

2. Description of the Related Art

U.S. Pat. No. 6,472,070 discloses a fire-resistant coating material containing a resin, a hardener, and an inorganic filler including a thermally expandable graphite.

U.S. Pat. No. 7,118,725 discloses expandable graphite intercalation compounds that are intercalated among lattice layers of the graphite. The intercalation compounds form a heat insulating layer after expansion to prevent heat transfer when the expandable graphite is heated by fire, thereby achieving a fire resistant effect. However, the conventional expandable graphite is disadvantageous in that it is incompatible with organic resins for mixing uniformly therewith for applications, such as fire-resistant paints, architecture materials, semiconductor packaging materials, and anti-static materials.

### SUMMARY OF THE INVENTION

Therefore, an object of the present invention is to provide a modified thermally expandable graphite that can overcome the aforesaid drawback associated with the prior art.

According to this invention, there is provided a modified thermally expandable graphite comprising a reaction product of an expandable graphite that contains an intercalation compound intercalated among lattice layers of the expandable graphite, and a silicon-containing organic compound that has at least one alkoxyl group and a reactive group subjected to reaction with the intercalation compound.

### BRIEF DESCRIPTION OF THE DRAWINGS

Other features and advantages of the present invention will become apparent in the following detailed description of the preferred embodiment of the invention, with reference to the accompanying drawing, in which:

FIG. 1 is a TGA thermogram for illustrating how different areas in the thermogram are used to calculate IPDT.

### DETAILED DESCRIPTION

This invention relates to a halogen-free and flame retardant material, more particularly to a halogen-free and flame retardant modified thermally expandable graphite.

In some embodiments of the modified thermally expandable graphite according to this invention comprises a reaction product of an expandable graphite that contains an intercalation compound intercalated among lattice layers of the expandable graphite, and a silicon-containing organic compound that has at least one alkoxyl group and a reactive group subjected to reaction with the intercalation compound.

In this embodiment, the silicon-containing organic compound is a silane compound having a formula (I)

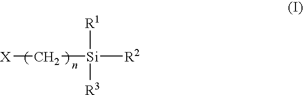

in which X defines the reactive group and is isocyanato, amino, or epoxyl group; R¹, R², and R³ are independently hydrogen, a C₁-C₆ alkyl group, or a C₁-C₆ alkoxyl group, and at least one of R¹, R², and R³ is a C₁-C₆ alkoxyl group; and n is an integer from 0 to 6.

In some embodiments, the intercalation compound contains at least one of a hydroxyl group and a carboxyl group for reaction with the isocyanato group of the silane compound, thereby permitting grafting of the silane compound to the expandable graphite.

In some embodiments, the silane compound is selected from the group consisting of 3-isocyanatopropyltriethoxysilane, m-aminophenyltrimethoxysilane, 3-aminopropyltriethoxysilane, 3-aminopropyltrimethoxysilane, and 3,4-epoxybutyltrimethoxysilane, and more preferably, the silane compound is 3-isocyanatopropyltriethoxysilane.

The grafting of the silane compound on the expandable graphite can be conducted in a solvent selected from the group consisting of tetrahydrofuran, isoamyl alcohol, isobutyl alcohol, isopropyl alcohol, ethyl ether, xylene, chlorobenzene, methyl ethyl ketone, N,N-dimethyl formamide, toluene, acetone, methanol, and combinations thereof. In some embodiments, the solvent is tetrahydrofuran. In addition, the grafting reaction is conducted under a high frequency oscillation condition at a temperature ranging from 30 to 60° C.

In some embodiments, the weight ratio of the expandable graphite to the silane compound ranges from 1:1 to 1:10, and more preferably, from 1:3 to 1:6.

The modified thermally expandable graphite contains the alkoxyl group(s) that can react with organic polymer(s) so as to enhance compatibility of the expandable graphite with the organic polymer or resin, and that can facilitate blending of the organic polymer with other agents, such as other fire-resistant agents and/or hardeners.

Suitable organic polymers include epoxy resin, phenolic-aldehyde resin, polyimide resin, urea resin, siloxane resin, melamine resin, unsaturated polyester, polymethyl methacrylate, polyethylene, polypropylene, acrylonitrile-butylene-styrene resin, polyvinyl chloride, nylon, polyacetal or polyoxymethylene, polycarbonate, and polyethylene terephathalate.

Suitable fire-resistant agents include a phosphor-containing compound, such as ammonium polyphosphate and triphenyl phosphate, a silicon-containing compound, such as tetraethoxysilane, metasilicate hydrate, and silicon dioxide particles, a nitrogen-containing compound, such as melamine and hexakis(methoxymethyl) melamine, a boron-containing compound, such as boric acid and tris(2-hydroxypropyl) borate, polyimide, aluminum hydroxide, magnesium hydroxide, and calcium carbonate.

The modified thermally expandable graphite of this invention can be used to react with a modified thermosetting polymeric precursor through sol-gel reaction so as to form a sol-gel reaction product of a graphite composite. A hardener can be added in the sol-gel reaction mixture so as to form a solidified product.

In some embodiments, the modified thermosetting polymeric precursor employed in the sol-gel reaction contains a thermosetting polymer that is grafted to a modifying compound and that is selected from the group consisting of epoxy resin, phenolic-aldehyde resin, polyimide resin, urea resin, polysiloxane resin, melamine resin, and unsaturated polyester.

In one embodiment, the modifying compound contains at least one alkoxyl group, and is preferably a silane compound of formula (I), such as 3-isocyanatopropyltriethoxysilane.

In some embodiments, the thermosetting polymer is epoxy resin.

In some embodiments, the weight ratio of the thermosetting polymer to the silane compound ranges from 1:1 to 6:1, and more preferably, from 1:1 to 3:1.

In some embodiments, the amount of the modified thermally expandable graphite ranges from 1 to 50 wt % based on the total weight of the graphite composite, and more preferably ranges from 10 to 50 wt %.

The sol-gel reaction is conducted in an acidic solution so as to permit the modified thermally expandable graphite and the modified thermosetting polymeric precursor to undergo hydrolysis reaction. After the hydrolysis reaction, the hardener is added into the mixture so as to permit the reaction mixture to undergo thermal condensation reaction or solidification to form a solidified graphite composite. In some embodiments, the sol-gel reaction is conducted at a temperature ranging from 60 to 180° C., and more preferably, from 100 to 180° C. In one embodiment, the hardener is preferably 4,4′-methylenedianiline. In some embodiments, the weight ratio of the graphite composite to the fire resistant agent ranges from 65:35 to 95:5, and more preferably, from 70:30 to 90:10.

The merits of the modified thermally expandable graphite of this invention will become apparent with reference to the following Examples and Comparative Examples.

### EXAMPLES

### Example 1 Preparation of the Modified Thermally Expandable Graphite

One gram of the thermally expandable graphite was added into 10 ml of tetrahydrofuran. 5 grams (0.02 mole) of 3-isocyanatopropyltriethoxysilane was then added into the mixture. The mixture was subjected to a high frequency oscillation under a temperature of 60° C. The modified thermally expandable graphite thus formed was analyzed using an IR spectrometry. An absorption peak at 1050-1100 cm⁻¹ was found, which indicates that the modified thermally expandable graphite thus formed contains a grafted group of Si—OC₂B₅.

### Examples 2-4 Preparation of the Graphite Composite

10 grams (0.028 mole) of DGEBA type epoxy resin (epoxy equivalent is 180) were added into 10 ml of tetrahydrofuran. 2.74 grams (0.011 mole) of 3-isocyanatopropyltriethoxysilane was then added into the mixture. The mixture was then subjected to stirring at a temperature of 60° C. so as to form the modified thermosetting polymeric precursor. An acidic solution was prepared by adding a suitable amount of HCL into a mixture of 10 ml of water and 10 ml of tetrahydrofuran. The modified thermally expandable graphite obtained from Example 1 was mixed with the modified thermosetting polymeric precursor thus formed in a ratio of 10:90, 20:80, and 30:70 for Examples 2-4, respectively. In each of the mixtures, the acidic solution was slowly added so as to obtain a liquid mixture. The liquid mixture was then subjected to high frequency oscillation for 2 hours. 2.65 grams of 4,4′-methylenedianiline were then added into the liquid mixture. The mixture was subjected to stirring and was heated to a temperature of 150° C. for 24 hours so as to obtain graphite composites for Examples 2-4.

### Examples 5-7 Preparation of Fire-Resistant Composition

The graphite composite obtained from Example 3 was mixed with tetraethoxysilane in a ratio of 90:10, 80:20, and 70:30 for Examples 5-7, respectively. Each of the mixtures was subjected to stirring and high frequency oscillation for 2 hours. 2.65 grams of 4,4′-methylenedianiline were then added into the liquid mixture. The liquid mixture was then heated to 150° C. for 24 hours so as to obtain the fire-resistant compositions for Examples 5-7, respectively.

### Comparative Example 1

Preparation of Comparative Example 1 differs from that of Examples 5-7 in that the thermosetting polymer (i.e., the epoxy resin) was not modified and that the modified thermally expandable graphite was dispensed with.

### Thermo Gravimetric Analysis (TGA)

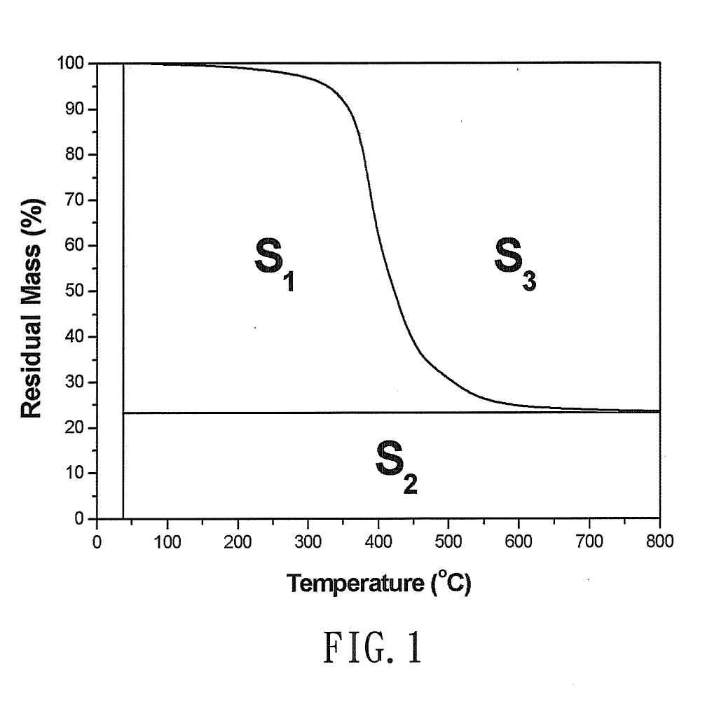

Specimens of Examples 2-4 and 5-7 were subjected to TGA. Results of the analysis are shown in Table 1. The abbreviation IPDT in Table 1 stands for Integral Procedure Decomposition Temperature, and is calculated by the following equation: IPDT (° C.)=A*K*(T_{f}−Tᵢ)+Tᵢ; where A*=(S₁+S₂)/(S₁+S₂+S₃) and K=(S₁+S₂)/(S₁); and where A* is the area ratio of total experimental curve defined by the total TGA thermogram, Tᵢ is the initial experimental temperature, T_{f} is the final experimental temperature, and S₁-S₃ represent different areas in the thermogram, as best illustrated in FIG. 1. The abbreviation LOI in Table 1 stands for limiting oxygen index, and is determined according to ASTM D 2863-77.

In TGA, the higher the Td₁₀, the higher the char yield, or the higher the IPDT, the higher will be the thermal stability for the test specimen. Moreover, the higher the L.O.I., the higher will be the fire resistance. The following values indicate the fire resistance of a specimen: at L.O.I.≦21, the test specimen is flammable, at 22 L.O.I.≦25, the test specimen is hard to burn, and at L.O.I.≦26, the test specimen is fire retardant.

TABLE 1

| | Td₁₀(° C.) | C.Y.(wt %) | IPDT(° C.) | L.O.I. |
|---|---|---|---|---|
| CE1 | 330.20 | 14.77 | 540.2 | 24 |
| E2 | 372.86 | 22.80 | 767.0 | 36 |
| E3 | 368.27 | 33.01 | 1030.9 | 39 |
| E4 | 331.68 | 39.93 | 1289.1 | 44 |
| E5 | 356.68 | 20.25 | 672.9 | 42 |
| E6 | 350.87 | 21.00 | 710.6 | 46 |
| E7 | 395.58 | 29.74 | 927.0 | 47 |

Td₁₀: temperature at 10% weight lost.
C.Y.: char yield.
IPDT: integral procedure decomposition temperature.
L.O.I.: limiting oxygen index.

The results show that Examples 2-7 have a higher thermal stability than that of Comparative Example 1, and exhibit excellent fire retardancy.

By grafting the expandable graphite with the silane compound of formula (I), the properties of the expandable graphite can be modified so as to be more compatible with those of organic polymer(s), thereby permitting uniform compounding of the expandable graphite and the organic polymer(s), which, in turn, enhances the fire resistance of the graphite composite formed therefrom.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A modified thermally expandable graphite comprising:
a reaction product of an expandable graphite that contains an intercalation compound intercalated among lattice layers of the expandable graphite, and a silicon-containing organic compound that has at least one alkoxyl group and a reactive group subjected to reaction with the intercalation compound.

2. The modified thermally expandable graphite of claim 1, wherein the silicon-containing organic compound is a silane compound having a formula (I): 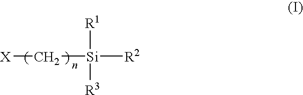
in which X defines the reactive group and is isocyanato, amino, or epoxyl group; R¹, R², and R³ are independently hydrogen, a C₁-C₆ alkyl group, or a C₁-C₆ alkoxyl group, and at least one of R¹, R², and R³ is a C₁-C₆ alkoxyl group; and n is an integer from 0 to 6.

3. The modified thermally expandable graphite of claim 1, wherein the intercalation compound contains at least one of a hydroxyl group and a carboxyl group.

4. The modified thermally expandable graphite of claim 2, wherein the silane compound is selected from the group consisting of 3-isocyanatopropyltriethoxysilane, m-aminophenyltrimethoxysilane, 3-aminopropyltriethoxysilane, 3-aminopropyltrimethoxysilane, and 3,4-epoxybutyltrimethoxysilane.

5. The modified thermally expandable graphite of claim 4, wherein the silane compound is 3-isocyanatopropyltriethoxysilane.

6. A graphite composite comprising:
a sol-gel reaction product of a modified thermally expandable graphite and a modified thermosetting polymeric precursor;
wherein the modified thermally expandable graphite comprises a reaction product of an expandable graphite that contains an intercalation compound intercalated among lattice layers of the expandable graphite, and a silicon-containing organic compound that has at least one alkoxyl group and a reactive group subjected to reaction with the intercalation compound.

7. The graphite composite of claim 6, wherein the silicon-containing organic compound is a silane compound having a formula (I) 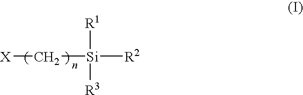
in which X defines the reactive group and is isocyanato, amino, or epoxyl group; R¹, R², and R³ are independently hydrogen, a C₁-C₆ alkyl group, or a C₁-C₆ alkoxyl group, and at least one of R¹, R², and R³ is a C₁-C₆ alkoxyl group; and n is an integer from 0 to 6.

8. The graphite composite of claim 6, wherein the intercalation compound is an acid.

9. The graphite composite of claim 6, wherein the intercalation compound contains at least one of a hydroxyl group and a carboxyl group.

10. The graphite composite of claim 7, wherein the silane compound is selected from the group consisting of 3-isocyanatopropyltriethoxysilane, m-aminophenyltrimethoxysilane, 3-aminopropyltriethoxysilane, 3-aminopropyltrimethoxysilane, and 3,4-epoxybutyltrimethoxysilane

11. The graphite composite of claim 6, wherein the modified thermosetting polymer precursor contains a thermosetting polymer that is grafted to a modifying compound and that is selected from the group consisting of epoxy resin, phenolic-aldehyde resin, polyimide resin, urea resin, polysiloxane resin, melamine resin, and unsaturated polyester, the modifying compound containing at least one alkoxyl group.

12. The graphite composite of claim 11, wherein the modifying compound is a silane compound of formula (I): 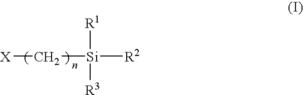
in which X is isocyanato, amino, or epoxyl group; R¹, R², and R³ are independently hydrogen, a C₁-C₆ alkyl group, or a C₁-C₆ alkoxyl group, and at least one of R¹, R², and R³ is a C₁-C₆ alkoxyl group; and n is an integer from 0 to 6.

13. The graphite composite of claim 12, wherein the thermosetting polymer is epoxy resin.

14. The graphite composite of claim 6, wherein the amount of the modified thermally expandable graphite ranges from 10 to 50 wt % based on the total weight of the modified thermally expandable graphite and the modified thermosetting polymer precursor.

15. A fire resistant material comprising:
a solidification product of a fire resistant composition comprising a graphite composite, a fire resistant agent, and a hardener;
wherein the graphite composite comprises a sol-gel reaction product of a modified thermally expandable graphite and a modified thermosetting polymeric precursor; and
wherein the modified thermally expandable graphite comprises a reaction product of an expandable graphite that contains an intercalation compound intercalated among lattice layers of the expandable graphite, and a silicon-containing organic compound that has at least one alkoxyl group and a reactive group subjected to reaction with the intercalation compound.

16. The fire resistant material of claim 15, wherein the silicon-containing organic compound is a silane compound having a formula (I): 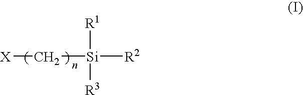
in which X defines the reactive group and is isocyanato, amino, or epoxyl group; R¹R² and R³ are independently hydrogen, a C₁-C₆ alkyl group, or a C₁-C₆ alkoxyl group, and at least one of R¹, R², and R³ is a C₁-C₆ alkoxyl group; and n is an integer from 0 to 6.

17. The fire resistant material of claim 15, wherein the fire resistant agent is selected from the group consisting of a phosphor-containing compound, a silicon-containing compound, a nitrogen-containing compound, a boron-containing compound, aluminum hydroxide, magnesium hydroxide, calcium carbonate, and combinations thereof.

18. The fire resistant material of claim 17, wherein the silicon-containing compound is tetraethoxysilane.

19. The fire resistant material of claim 15, wherein the weight ratio of the graphite composite to the fire resistant agent ranges from 65:35 to 95:5.

20. The fire resistant material of claim 15, wherein the hardener is 4,4′-methylenedianiline.
